(19) United States
(12) Patent Application Publication
(10) Pub. No.: US 2018/0295850 A1
(43) Pub. Date: Oct. 18, 2018

(54) EMULSIFIED CHEESE PRODUCT

(71) Applicant: ORNUA INGREDIENTS NORTH AMERICA, Hilbert, WI (US)

(72) Inventors: Tony McCarthy, Hilbert, WI (US); Kyle Kelvington, Hilbert, WI (US); Chris Rentmeester, Hilbert, WI (US); Michelle McWane, Hilbert, WI (US)

(21) Appl. No.: 15/947,249

(22) Filed: Apr. 6, 2018

Related U.S. Application Data
(63) Continuation of application No. 62/485,374, filed on Apr. 13, 2017.

(51) Int. Cl. A23C 19/082

(52) U.S. Cl. CPC A23C 19/082; A23V 2002/00; A23V 2300/41; A23V 2250/032; A23V 2200/222

(57) ABSTRACT

Provided are methods for producing a low-sodium emulsified cheese product using a citric acid source.

### CROSS REFERENCE TO RELATED APPLICATIONS

This application claims priority to U.S. Provisional Application No. 62/485,374, filed Apr. 13, 2017, which is incorporated herein by reference in its entirety.

### TECHNICAL FIELD

The present disclosure relates to methods of producing low-sodium emulsified cheese product using a citric acid source.

### BACKGROUND

The market for cheese in the United States is estimated at 11.5 billion pounds per year. Of that market, process cheese is estimated to account for about 30%. Process cheese has stable emulsion properties that are desirable for numerous applications, allowing process cheeses to be maintained at elevated temperatures for extended periods of time or subjected to repeated heating and cooling cycles while maintaining a smooth texture and without separating.

Conventional process cheese contains substantial amounts of sodium. The sodium content of process cheese is typically in the range of 1200 to 1800 mg of sodium per 100 g of process cheese. The sodium content of process cheese comes typically from the following sources and approximate proportions: 50% from one or more emulsifiers (such as sodium phosphates), 25% from the natural cheese used as an ingredient in the process cheese, and about another 25% from sodium chloride added by the process cheese manufacturer as an ingredient in the process cheese. Sodium chloride, also more commonly known as table salt, is approximately 40% sodium by weight. Elevated dietary sodium intake is known to contribute to high blood pressure and the risk of coronary heart disease.

### SUMMARY

The disclosure provides a method for producing an emulsified cheese product, comprising mixing ingredients comprising natural cheese in an amount from about 45% to about 90% by weight, a carbonate in an amount from about 0.5% to about 1.0% sodium carbonate equivalent by weight, and a citric acid source in an amount from about 3% to about 5% lemon juice concentrate equivalent by weight to form a mixture. The disclosed methods may further comprise heating the mixture to a heated temperature between about 150° and about 180° F. and cooling the mixture to less than about 40° F.

The disclosure also provides emulsified cheese products. In some embodiments, the disclosed emulsified cheese products may be produced by the processes disclosed herein. In some embodiments, the disclosed emulsified cheese products may comprise about 38% to about 52% moisture, about 15% to about 35% fat, about 15% to about 22% protein, at least about 4 mg ascorbic acid per 100 g emulsified cheese product, and about 950 mg or less sodium per 100 g emulsified cheese product.

The disclosure also provides a method for producing an emulsified cheese product. The method comprises: mixing ingredients comprising natural cheese in an amount from about 45% to about 90% by weight, an alkali in an amount from about 0.1% to about 1.0% sodium carbonate equivalent by weight to result in a emulsified cheese product having a pH of about 5.0 to about 6.0, and a citric acid source in an amount from about 3.0% to about 5.0% lemon juice concentrate equivalent by weight to form a mixture; heating the mixture to a heated temperature between about 150° F. and about 180° F.; and cooling the mixture to less than about 40° F.

An emulsified cheese product produced according to said methods.

### BRIEF DESCRIPTION OF DRAWINGS

FIG. 1 shows a mixture of 38 g sodium bicarbonate in a solution with 8 g of citric acid, showing a cloudy precipitate of sodium bicarbonate.

FIG. 2 shows data from two separate trials adding carbonates to 8 g of citric acid, with resulting pH recorded.

### DETAILED DESCRIPTION

### 1. Definitions

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing of the present invention. All publications, patent applications, patents and other references mentioned herein are hereby incorporated by reference in their entirety. The materials, methods, and examples disclosed herein are illustrative only and not intended to be limiting.

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

“About” is used synonymously herein with the term “approximately.” Illustratively, the use of the term “about” indicates that values slightly outside the cited values, namely, plus or minus 10%. Such values are thus encompassed by the scope of the claims reciting the terms “about” and “approximately.”

“Aged cheese” refers to cheese that has been cured for at least 6 months.

“Alkali” refers to a substance having marked basic properties. For example, an alkali can include any suitable food grade alkaline ingredients other than the ones found in the “Emulsifier” list below, such as carbonate, sodium hydroxide and potassium hydroxide.

“Carbonate” refers to all the salts of carbonic acid (H₂CO₃), for example, sodium carbonate (Na₂CO₃), sodium bicarbonate (NaHCO₃), potassium carbonate, and potassium bicarbonate, among others known to a person of ordinary skill in the art.

“Comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “an” and “the” include plural references unless the context clearly dictates otherwise. The present disclosure also contemplates other embodiments “comprising,” “consisting of” and “consisting essentially of,” the embodiments or elements presented herein, whether explicitly set forth or not.

“Emulsifier” refers to as one or any mixture of two or more of the following: monosodium phosphate, disodium phosphate, dipotassium phosphate, trisodium phosphate, sodium metaphosphate (sodium hexametaphosphate), sodium acid pyrophosphate, tetrasodium pyrophosphate, sodium aluminum phosphate, sodium citrate, potassium citrate, calcium citrate, sodium tartrate, and sodium potassium tartrate. Emulsifiers are added during the manufacture of process cheeses to help hydrate or solubilize cheese proteins which in turn can then form an emulsion with the butter fat, inhibiting separation. Also, if the proteins are not adequately hydrated they can impart a chalky, gritty/coarse texture.

“Citrus juice” refers to the juice extracted from a citrus fruit, and unless specified should be taken to include fresh squeezed citrus juices of one or more types of citrus fruit, and/or one or more citrus juices in concentrated or powdered form. Exemplary citrus juices include lemon juice, lime juice, orange juice, grapefruit juice, and pomelo juice.

“Natural cheese” refers to a concentrated dairy food made from milk, being the fresh or matured product obtained by draining the whey (the moisture or serum of the original milk) after coagulation of casein, milk's major protein. Casein is coagulated by acid produced by select microorganisms and/or by coagulating enzymes, resulting in curd formation.

“Pasteurized process cheese” refers to food prepared by comminuting and mixing, with the aid of heat, components comprising one or more cheeses of the same or two or more varieties, except cream cheese, Neufchatel cheese, cottage cheese, low-fat cottage cheese, cottage cheese dry curd, cook cheese, hard grating cheese, semisoft part-skim cheese, part-skim spiced cheese, and skim milk cheese for manufacturing with an emulsifier into a homogeneous plastic mass. During its preparation, pasteurized process cheese is heated for not less than 30 seconds at a temperature of not less than 150° F. In some cases, a pasteurized process cheese may contain one or any mixture of two or more of the following: any properly prepared cooked, canned, or dried fruit; any properly prepared cooked, canned, or dried vegetable; any properly prepared cooked or canned meat.

“Pasteurized process cheese food” refers to food prepared by comminuting and mixing, with the aid of heat, components comprising one or more cheese ingredients with one or more dairy ingredients into a homogeneous plastic mass. One or more emulsifiers are used. During its preparation, a pasteurized process cheese food is heated for not less than 30 seconds, at a temperature of not less than 150° F. Cheese ingredients used in pasteurized process cheese food are one or more cheeses of the same or two or more varieties, except cream cheese, Neufchatel cheese, cottage cheese, creamed cottage cheese, cook cheese, and skim-milk cheese for manufacturing, and except that hard grating cheese, semisoft part skim cheese, and part-skim spiced cheese are not used alone or in combination with each other as the cheese ingredient. Dairy ingredients used in pasteurized process cheese food are cream, milk, skim milk, buttermilk, cheese whey, any of the foregoing from which part of the water has been removed, anhydrous milkfat, dehydrated cream, albumin from cheese whey, and skim milk cheese for manufacturing.

“Pasteurized process cheese spread” refers to the food prepared by comminuting and mixing, with the aid of heat, components comprising one or more cheese ingredients with or without one or more dairy ingredients, with one or more emulsifiers, into a homogeneous plastic mass, which is spreadable at 70° F. During its preparation, a pasteurized process cheese spread is heated for not less than 30 seconds at a temperature of not less than 150° F. Cheese ingredients used in pasteurized process cheese spread are one or more cheeses of the same or two or more varieties, except that skim-milk cheese for manufacturing may not be used, and except that cream cheese, Neufchatel cheese, cottage cheese, creamed cottage cheese, cook cheese, hard grating cheese, semisoft part-skim cheese, and part-skim spiced cheese are not used, alone or in combination with each other, as the cheese ingredient. Dairy ingredients used in pasteurized process cheese spread are cream, milk, skim milk, buttermilk, cheese whey, any of the foregoing from which part of the water has been removed, anhydrous milkfat, dehydrated cream, albumin from cheese whey, and skim milk cheese for manufacturing.

“Pasteurized process cheese product” refers to cheese products that do not fit the definitions for a pasteurized process cheese, pasteurized process cheese food, pasteurized process cheese spread provided herein but are made by mixing natural and/or process cheese together with heat and one or more emulsifiers.

“Process cheese” refers to the broad category of products that use one or more varieties of natural cheese combined with emulsifiers and a heat treatment to form a homogenous product, such as pasteurized process cheese, pasteurized process cheese spread, pasteurized process cheese food, pasteurized process cheese product, and all the aforementioned with or without another food.

“Young cheese” refers to a cheese that has been cured for less than 30 days.

### 2. Methods

The inventors have developed specific technologies including emulsified cheese products and processes to make them, to produce a cheese product that achieves the functionality of a process cheese, with a stable emulsion and flavor equally acceptable to consumers, but with significantly reduced sodium achieved by removing emulsifiers as an ingredient during production of the emulsified cheese products.

For clarity, the innovative technologies described here are not “process cheese,” since they do not involve the use emulsifiers during production. Due to the critical function performed by emulsifiers in process cheese, most efforts to reduce sodium in process cheese have focused on the sodium chloride added during process cheese production. Because that sodium chloride imparts desirable flavor, “reduced sodium” process cheeses have not found great success amongst consumers. The methods and compositions disclosed here allow reducing sodium to about 950 mg sodium or less per 100 g of cheese product. Because the disclosed technologies achieve sodium reductions by eliminating traditional emulsifiers (which do not impart a significant salt flavor), the disclosed technology does not result in a loss of flavor. Taste panels in fact indicate a slight preference for the disclosed emulsified cheese products over traditional process cheese.

Given typical sodium levels of 1200 to 1800 mg of sodium per 100 g of process cheese, if the disclosed technologies were used across the cheese industry, an estimated reduction of about 250 to about 850 mg of sodium per 100 g of product could be achieved. This would result in the removal of 52 million pounds of sodium per year from the U.S. diet, or the equivalent of removing over 130 million pounds of table salt (sodium chloride).

The present disclosure provides methods for producing an emulsified cheese product without the use of an emulsifier. The disclosed methods may comprise mixing ingredients comprising natural cheese in an amount from about 45% to about 90% by weight, carbonate in an amount from about 0.5% to about 1.0% sodium carbonate equivalent by weight, and a citric acid source in an amount from about 3% to about 5% lemon juice concentrate equivalent by weight to form a mixture; heating the mixture to a heated temperature between about 150° and about 180° F.; and cooling the mixture to less than about 40° F. The ingredients do not include an emulsifier. The citric acid source may comprise a citrus juice, such as, for example, lemon juice concentrate or lemon juice.

The present disclosure also provides methods for producing an emulsified cheese product without the use of emulsifier. The disclosed methods may comprise mixing ingredients comprising natural cheese in an amount from about 45% to about 90% by weight, and a citric acid source in an amount from about 3% to about 5% lemon juice concentrate equivalent by weight to form a mixture, and an alkali, such as sodium carbonate, in an amount from about 0.1% to about 2% to achieve or result in a finished product, such as an emulsified cheese product, having a pH of about 5.0 to about 6.0, more ideally about 5.6 to about 5.8; heating the mixture to a heated temperature between about 150° F. and about 180° F.; and cooling the mixture to less than about 40° F. The ingredients do not include an emulsifier. The citric acid source may comprise a citrus juice, such as, for example, lemon juice concentrate or lemon juice.

a. Ingredients

One of ordinary skill in the art will recognize that certain ingredient substitutions and ingredient additions are possible that will yield substantially similar results.

Emulsifier.

In the disclosed methods, the ingredients do not include an emulsifier.

Natural Cheese.

A variety of natural cheeses such as cheddar, Edam, mozzarella, Swiss, Gouda, Parmesan, Asiago, and cream cheese, among others, can be used alone or in combination to obtain different flavor nuances. While each of these contains varying moisture, protein, and fat contents, one skilled in the art can adjust added moisture, added fat, and/or nonfat dry milk to achieve a desired product composition and texture similar finished to the products described herein. Since compositions can vary among particular natural cheeses, it will be useful for the skilled formulator to know the finished composition (such as moisture, fat, and protein content) of a desired emulsified cheese product so that they can reproduce it using a desired complement of one or more natural cheeses and other ingredients.

Those skilled in the art of process cheese will readily recognize that a variety of natural cheeses, at different ages, can be used alone or in combination to obtain different texture, functional, and flavor nuances. In some embodiments, a natural cheese can include a young cheese, an aged cheese, or a combination thereof. Typically, if using emulsifiers, young cheese require more emulsifier than an older cheese, thus, the more young cheese is used, the more emulsifier is needed. In the disclosed methods, the levels of the citric acid source and/or alkali can be increased or decreased to optimize emulsion stability when different amounts or percentages of young cheese and aged cheese are used.

In some embodiments, the natural cheese can include between about 0% to about 100% of young cheese, such as between about 5% to about 100%, between about 10% to about 100%, between about 20% to about 100%, between about 30% to about 100%, between about 40% to about 100%, between about 50% to about 100%, between about 60% to about 100%, between about 70% to about 100%, between about 80% to about 100%, between about 90% to about 100%, between about 5% to about 90%, between about 10% to about 90%, between about 20% to about 90%, between about 30% to about 90%, between about 40% to about 90%, between about 50% to about 90%, between about 60% to about 90%, between about 70% to about 90%, between about 80% to about 90%, between about 5% to about 80%, between about 10% to about 80%, between about 20% to about 80%, between about 30% to about 80%, between about 40% to about 80%, between about 50% to about 80%, between about 60% to about 80%, between about 70% to about 80%, between about 5% to about 50%, between about 10% to about 50%, between about 20% to about 50%, between about 30% to about 50%, or between about 40% to about 50% of young cheese. In some embodiments, the natural cheese can include at least about 5%, at least about 10%, at least about 20%, at least about 30%, at least about 40%, at least about 50%, at least about 60%, at least about 70%, at least about 80%, at least about 90%, or at least about 95% of young cheese. In some embodiments, the natural cheese can include at most about 100%, at most about 90%, at most about 80%, at most about 70%, at most about 60%, at most about 50%, at most about 40%, at most about 30%, at most about 20%, at most about 10%, or at most about 5% of young cheese.

In some embodiments, the natural cheese can include between about 0% to about 100% of aged cheese, such as between about 5% to about 100%, between about 10% to about 100%, between about 20% to about 100%, between about 30% to about 100%, between about 40% to about 100%, between about 50% to about 100%, between about 60% to about 100%, between about 70% to about 100%, between about 80% to about 100%, between about 90% to about 100%, between about 5% to about 90%, between about 10% to about 90%, between about 20% to about 90%, between about 30% to about 90%, between about 40% to about 90%, between about 50% to about 90%, between about 60% to about 90%, between about 70% to about 90%, between about 80% to about 90%, between about 5% to about 80%, between about 10% to about 80%, between about 20% to about 80%, between about 30% to about 80%, between about 40% to about 80%, between about 50% to about 80%, between about 60% to about 80%, between about 70% to about 80%, between about 5% to about 50%, between about 10% to about 50%, between about 20% to about 50%, between about 30% to about 50%, or between about 40% to about 50% of an aged cheese. In some embodiments, the natural cheese can include at least about 5%, at least about 10%, at least about 20%, at least about 30%, at least about 40%, at least about 50%, at least about 60%, at least about 70%, at least about 80%, at least about 90%, or at least about 95% of an aged cheese. In some embodiments, the natural cheese can include at most about 100%, at most about 90%, at most about 80%, at most about 70%, at most about 60%, at most about 50%, at most about 40%, at most about 30%, at most about 20%, at most about 10%, or at most about 5% of an aged cheese.

Alkali.

An alkali may be used in the disclosed methods. In some embodiments, the alkali can be potassium hydroxide, sodium hydroxide, a carbonate or a salt thereof, bicarbonate or a salt there, or a combination thereof. In some embodiments, the alkali can be sodium bicarbonate, potassium carbonate, or potassium bicarbonate. Potassium can have a slightly bitter flavor when used at high levels, but potassium carbonates are perfectly acceptable substitutes for sodium carbonates. However, potassium has a higher atomic weight than sodium, so to maintain the equivalent molar quantity, one would need about 30% more of a potassium carbonate to achieve the same as its sodium counterpart. The bicarbonate versions of these salts are also acceptable. Using bicarbonate increases the amount needed and the amount of CO₂ generated that also needs to be removed if one wishes to obtain a texture that is free from gas bubbles.

When determining the amount of alkali such as sodium carbonate, sodium bicarbonate, potassium carbonate, and/or potassium bicarbonate to use as an ingredient in preparing an emulsified cheese product in accordance with this disclosure, the necessary amount of alkali is expressed herein in terms of a “sodium carbonate equivalent” (see Table 1). For example, if the alkali used for preparing a particular emulsified cheese product is 0.8% by weight sodium carbonate equivalent, that alkali could be provided using 0.8% by weight sodium carbonate (0.8%×1 part). If the same sodium carbonate equivalent is to be supplied in the form of potassium carbonate, 1.04% by weight potassium carbonate would be used (0.8%×1.3 parts). Thus, Table 1 may aid in selecting the appropriate amount and type of alkali to provide the desired alkalinity or “sodium carbonate equivalent”.

TABLE 1
Sodium Carbonate Equivalents

| Carbonic Acid Salt | Parts Per Sodium Carbonate Equivalent | |
|---|---|---|
| Sodium carbonate | 1.0 | part |
| Potassium carbonate | 1.3 | parts |
| Sodium bicarbonate | 1.6 | parts |
| Potassium bicarbonate | 1.9 | parts |
| Sodium Hydroxide | 0.75 | parts |
| Potassium Hydroxide | 1.3 | parts |

In some embodiments, the amount of alkali used may be from about 0% by weight to about 1% by weight sodium carbonate equivalent. In some embodiments, the amount of alkali used may be from about 0.5% by weight to about 1.0% by weight sodium carbonate equivalent. In some embodiments, the amount of sodium carbonate equivalent may be from about 0.6% by weight to about 0.9% by weight sodium carbonate equivalent. In some embodiments, the amount of carbonate may be about 0.5%, about 0.6%, about 0.7%, about 0.8%, about 0.9%, about 1.0%, about 1.1%, about 1.2%, about 1.3%, about 1.4%, or about 1.5% by weight sodium carbonate equivalent.

The amount of alkali needed can vary, and is determined by the desired pH for a finished emulsified cheese product. In some embodiments, a desired pH may be between about 5.0 and about 6.0, in some preferred embodiments between about 5.6 and about 5.8. Certain natural cheeses may have more acidity than others and the skilled formulator will be able to make the necessary adjustments to achieve the desired pH. In general, higher pH's require more alkali, indeed certain formulations with lower targeted pH may not require any alkali.

Carbonate.

Sodium carbonate may be used as a carbonate in some preferred embodiments, but other salts of carbonic acid can also be used, including but not limited to sodium bicarbonate, potassium carbonate, and potassium bicarbonate. Potassium can have a slightly bitter flavor when used at high levels, but potassium carbonates are perfectly acceptable substitutes for sodium carbonates. However, potassium has a higher atomic weight than sodium, so to maintain the equivalent molar quantity, one would need about 30% more of a potassium carbonate to achieve the same as its sodium counterpart. The bicarbonate versions of these salts are also acceptable. Using bicarbonate increases the amount needed and the amount of CO₂ generated that also needs to be removed if one wishes to obtain a texture that is free from gas bubbles.

When determining the amount of a carbonic acid salt such as sodium carbonate, sodium bicarbonate, potassium carbonate, and/or potassium bicarbonate to use as an ingredient in preparing an emulsified cheese product in accordance with this disclosure, the necessary amount of carbonate is expressed herein in terms of a “sodium carbonate equivalent” (see Table 2). For example, if the carbonate needed for preparing a particular emulsified cheese product is 0.8% by weight sodium carbonate equivalent, that carbonate could be provided using 0.8% by weight sodium carbonate (0.8%×1 part). If the same sodium carbonate equivalent is to be supplied in the form of potassium carbonate, 1.04% by weight potassium carbonate would be used (0.8%×1.3 parts). Thus, Table 2 may aid in selecting the appropriate amount of a particular salt of carbonic acid to provide the desired sodium carbonate equivalent.

TABLE 2
Sodium Carbonate Equivalents

| Carbonic Acid Salt | Parts Per Sodium Carbonate Equivalent |
|---|---|
| Sodium carbonate | 1.0 part |
| Potassium carbonate | 1.3 parts |
| Sodium bicarbonate | 1.6 parts |
| Potassium bicarbonate | 1.9 parts |

In some embodiments, the amount of carbonate used may be from about 0.5% by weight to about 2.0% by weight sodium carbonate equivalent. In some embodiments, the amount of carbonate used may be from about 0.5% by weight to about 1.0% by weight sodium carbonate equivalent. In some embodiments, the amount of carbonate may be from about 0.6% by weight to about 0.9% by weight sodium carbonate equivalent. In some embodiments, the amount of carbonate may be about 0.5%, about 0.6%, about 0.7%, about 0.8%, about 0.9%, about 1.0%, about 1.1%, about 1.2%, about 1.3%, about 1.4%, or about 1.5% by weight sodium carbonate equivalent.

The amount of carbonate can vary, and may be determined in view of a desired pH for a finished emulsified cheese product. In some embodiments, a desired pH may be between about 5.0 and about 6.0, in some preferred embodiments between about 5.6 and about 5.8. Certain natural cheeses may have more acidity than others and the skilled formulator will be able to make the necessary adjustments to achieve the desired pH.

Citric Acid Source.

Various citric acid sources can be used for carrying out the disclosed methods and preparing the disclosed products. In some preferred embodiments, one or more citrus juices may be used, such as lemon juice concentrate, fresh squeezed or single-strength lemon juice, lime juice concentrate, or fresh squeezed or single-strength lime juice. Lemon juice concentrate and lemon juice are preferred. Lime juice and lemon juice (and thus their respective concentrates) have similar sugar and citric acid levels, but lime juice has a stronger flavor lime than lemon juice. Orange juice and orange juice concentrate may be used in some embodiments, but because of the relatively high sugar content and low citric acid levels, orange juice and orange juice concentrate are not preferred. In some embodiments, citric acid may be used as a citric acid source. Citric acid can serve as a less expensive citric acid source, but citric acid is devoid of the antioxidants naturally present in the lemon juice and does not provide the same flavor profile as citrus juice.

When determining the amount of a citric acid source such as lemon juice concentrate, lemon juice, lime juice concentrate, lime juice, and/or citric acid to use as an ingredient in preparing an emulsified cheese product in accordance with this disclosure, the necessary amount of citric acid source is expressed herein in terms of a “lemon juice concentrate equivalent” (see Table 2) needed to provide an equivalent amount of citric acid as would be provided in the stated amount of lemon juice concentrate. For example, if the citric acid source needed for preparing a particular emulsified cheese product is 3.0% by weight lemon juice concentrate equivalent, the equivalent amount of citric acid could be provided using 3.0% by weight lemon juice concentrate (3.0%×1 part). If the same 3.0% by weight lemon juice concentrate equivalent is to be supplied in the form of single-strength lime juice, 18.6% by weight single-strength lime juice would be used (3.0%×6.2 parts) to provide the equivalent amount of citric acid. To supply 3.0% by weight lemon juice concentrate equivalent in the form of citric acid, 0.93% by weight citric acid would be used (3.0%×0.31 parts). One skilled in the art will recognize that increasing the volume of citric acid source used (for example, when replacing lemon juice concentrate with single-strength lime juice) would require rebalancing the formulation by reducing added water, and vice versa. Thus, Table 3 may aid in selecting the appropriate amount of a citric acid source to provide the desired lemon juice concentrate equivalent.

TABLE 3
Lemon Juice Concentrate Equivalents

| Citric Acid | % Citric | | Parts Per Lemon Juice | |
|---|---|---|---|---|
| Source | Acid | % Sugar | Concentrate Equivalent | |
| Lemon juice | 31 | 13 | 1.0 | part |
| concentrate | | | | |
| Lemon juice | 5 | 2 | 6.2 | parts |
| single strength | | | | |
| Lime juice | 30 | 14 | 1.03 | parts |
| concentrate | | | | |
| Lime juice | 5 | 2 | 6.2 | parts |
| single strength | | | | |
| Grapefruit juice | 2 | 9 | 15.5 | parts |
| Orange juice | 0.9 | 8 | 34.4 | parts |
| Citric acid | 100 | 0 | 0.31 | parts |

In some embodiments, the amount of citric acid source used may be from about 2.0% by weight to about 6.0% by weight lemon juice concentrate equivalent. In some embodiments, the amount of citric acid source used may be from about 3.0% by weight to about 5.0% by weight lemon juice concentrate equivalent. In some embodiments, the amount of citric acid source may be from about 3.3% by weight to about 4.5% by weight lemon juice concentrate equivalent. In some embodiments, the amount of citric acid source may be about 3.0%, about 3.1%, about 3.2%, about 3.3%, about 3.4%, about 3.5%, about 3.6%, about 3.7%, about 3.8%, about 3.9%, or about 4.0% by weight lemon juice concentrate equivalent.

As mentioned, lemon juice concentrate is a preferred citric acid source, for at least the following reasons: (a) the higher solids relative to single-strength citrus juice allows for greater formulation flexibility, (b) lemon juice concentrate has a high citric acid to sugar ratio, (c) the lemon flavor is slightly milder and less noticeable in the finished application than the harsher lime flavor, (d) for a given quantity of citric acid, the flavor impact of the concentrate form is less intense than the single-strength or raw juices. At too high levels of citrus juice, such as lemon juice concentrate, the citrus flavor comes through more prominently in the emulsified cheese product, and at too low levels the emulsion suffers.

Surprisingly, the disclosed methods and emulsified cheese products do not result in an unpleasant flavor. Citrus juices, such as lemon juice, have a strong and distinctive flavor which a person of ordinary skill in the art would have expected to impart an odd or unpleasant flavor when used in combination with cheese. The methods and products disclosed here surprisingly do not suffer from this odd flavor problem. While not wishing to be bound by theory, it is believed that expected, undesirable citrus flavor is mitigated by one or more of the following complimentary and additive mechanisms associated with the disclosed processes and products: (1) The preferred citric acid source is lemon juice concentrate, which is typically subjected to heat and vacuum during manufacturing and may thereby remove some of the citrus flavor notes. (2) The disclosed processes involve heating the mixture to 150° F. or higher, which may turn volatile flavor compounds into a gas form which may then escape from the mixture. Indeed during manufacture, the citrus odor can be detected coming off of the mixture. (3) Use of a vacuum may remove volatile citrus flavors from the mixture. (4) During the reaction between the citric acid source and the carbonate, CO₂ is generated, which may also contribute to removal of flavors akin to supercritical CO₂ extraction of aromas. (5) Steam injection is the preferred heating method, which may lead to flavor removal akin to steam stripping of off flavors from crude vegetable oils. (6) During the production, the ingredients are gently mixed, which helps reduce the distance that volatile flavor compounds have to travel in order to escape and greatly enhances their removal. (7) Citrus juice contains components like vitamin c (ascorbic acid) that can act as antioxidants, which may protect the flavor of the emulsified cheese product by reducing free radicals associated with oxidation or rancidity of food.

Optional Ingredients.

Other ingredients known to one of ordinary skill in the art may be used for purposes such as achieving a desired flavor, texture, or other property such as moisture, fat, or protein content. Optional ingredients may include, for example, one or more of a butterfat source, an amphipathic molecule, and a hydrocolloid.

In some embodiments, a butterfat source may be used, such as anhydrous milk fat, butter, concentrated milk fat, or cream of varying fat percentages (such as 40% fat, 30% fat, etc.). Using Table 4, one of skill in the art could similarly calculate the amounts of one or more butterfat sources to achieve a desired anhydrous milk fat equivalent. For example, if the desired anhydrous milk fat equivalent is 3.6% by weight, that anhydrous milk fat equivalent could be provided using 3.6% by weight anhydrous milk fat (3.6%×1 part). If the same anhydrous milk fat equivalent is to be supplied using cream having 40% fat, 9% by weight of cream (having 40% fat) would be used (3.6%×2.5 parts). Again, one skilled in the art would reduce moisture to achieve a similar finished composition.

TABLE 4

| | Parts Per Anhydrous Milk |
|---|---|
| Butterfat Source | Fat Equivalent |
| Anhydrous milk fat | 1.0 part |
| Butter | 1.2 parts |
| Concentrated milk fat | 1.2 parts |
| Cream (40% fat) | 2.5 parts |
| Cream (30% fat) | 3.3 parts |

In some embodiments, an amphipathic molecule may be used. Molecules such as free fatty acids and lecithin which have both water loving (hydrophilic) and water hating (hydrophobic) regions can serve to improve stability of the disclosed emulsified cheese products and also to modulate protein-protein interaction to reduce the propensity to of proteins to come together to form chalky/gritty complexes. Again, while not wishing to be bound by the theory, proteins may be attracted to each other via a range of mechanisms, including some that are hydrophobic and/or hydrophilic in nature. An amphipathic molecule may be generally smaller and more mobile than intact dairy proteins such as casein and so can participate in those interactions with the protein before the protein can complex with itself, thus reducing protein-protein interactions to yield an emulsified cheese product that is smoother in texture.

In some embodiments, using an aged natural cheese as an ingredient may provide a source of amphipathic molecules. Under controlled aging conditions, much of the cheese protein may break down into smaller, more mobile peptides, which range from predominantly hydrophobic to predominantly hydrophilic. Without wishing to be bound by theory, such peptides in aged natural cheese may be capable of engaging in interactions with intact proteins such as casein and reducing protein-protein interactions between such intact proteins and provide a smoother texture and more stable emulsion. In some embodiments, at least 10% of the total natural cheese used in the emulsified cheese product is at least 6 months old.

In some embodiments, a hydrocolloid may be used and may impart different textures and properties like melt restriction and freeze thaw stability. Hydrocolloids may include, for example, gums and starches. Gums like guar gum and xanthan gum may have little protein interaction but nonetheless increase viscosity, and may thereby increase the effectiveness of mechanical shear in separating protein and reducing the rate at which proteins can re-aggregate. Hydrocolloids with either ionic or hydrophobic regions, such as high methoxy pectin and locust bean gum, may interact more with proteins, providing some of the functionality of an amphipathic molecule along with increased viscosity.

b. Processing Steps

Mixing Ingredients to Form a Mixture.

Some or all of the ingredients may be mixed together at once or in stages to form a mixture. In some embodiments, all ingredients may be mixed together at the same time, including natural cheese, carbonate, citric acid source, desired optional ingredients, and water. In some embodiments, a subset of ingredients may be mixed together before one or more other ingredients are incorporated. For example, in some embodiments that include water as an ingredient, a subset of ingredients not including water may be mixed together before incorporating water. Reserving water from the initial subset of ingredients may allow for a more finely comminuted mixture and quicker, more complete hydration in subsequent steps.

As another example, in some embodiments a subset of ingredients not including a citric acid source may be mixed together before incorporating the citric acid source. Reserving a citric acid source when mixing together an initial subset of ingredients may allow a carbonate to interact with ingredients in the initial subset (such as a natural cheese) and establish an elevated pH and can help to solubilize proteins more completely before adding a citric acid source, resulting in improved texture and stability of the emulsified cheese product. A subset of ingredients not including a citric acid source may be mixed and/or held for a period of time before adding a citric acid source, for example, one to five minutes. Reserving the citric acid source for addition to a pre-mixed subset of ingredients can allow more complete protein hydration and this can result in different textures and flavor profiles in the finished product. Once a citric acid source is added, additional mixing time is preferably allowed (for example, one to five minutes) to accomplish uniform distribution and to allow the CO₂ gas liberated by the reaction of the citric acid source with the carbonate. Product may expand and potentially overflow the vessel if sufficient head-space is not planned for or the citric acid source is added too quickly.

One or more ingredients reserved from the initial subset of ingredients may be incorporated simultaneously or in sequence. Additional mixing may be performed to achieve a homogenous mixture as each ingredient or subset of ingredients is added.

Mixing may be performed using any suitable mixing apparatus known to those of ordinary skill in the art, such as a Stephan bowl chopper. The Stephan Universal Machines UM 70/130/200 are suitable but one skilled in the art will recognize that the same or similar size reduction and mixing can be achieved by a variety of ways and equipment combinations. In general, at each mixing stage, the smaller the size of the ingredient particles the more quickly they will hydrate and the more homogenous the finished product will tend to be.

Heating.

After the desired ingredients have been mixed together to form a mixture, the mixture may be heated to a desired heated temperature. Before heating, the mixture may be transferred from a mixing apparatus to a heating apparatus, and in some embodiments, the heating apparatus may be configured to apply mechanical shear to the mixture during heating. For example, a twin-screw cheese cooker may be used as a heating apparatus, but other suitable heating apparatuses will be known to those of ordinary skill in the art. Water may be added before or after transferring the mixture to a heating apparatus, and water may be added before and/or during heating. In some embodiments, steam may be injected or otherwise applied to the mixture to achieve a desired heated temperature through direct steam heating. Direct steam injection is preferred as it aids in removal of CO₂ generated by the mixture and is a gentle heating method that minimizes burn on. Preferably, the steam used should be culinary grade. The amount of steam needed to achieve a particular heated temperature depends on the initial temperature of the mixture and the desired heated temperature. In some embodiments, the mixture may be heated using other direct or indirect heating mechanisms known to those of ordinary skill in the art.

In some embodiments, heating the mixture may achieve a heated temperature between about 150° C. and about 180° F., more preferably between about 160° F. and about 165° F. In some embodiments, the mixture may be held at a heated temperature for a period of time, such as, for example, about 10 seconds to about 5.0 minutes, more preferably from about 30 seconds to about 60 seconds. Heating should be sufficient to ensure that microbial pathogens are destroyed. Heating below 150° F. for 30 seconds is not recommended for food safety reasons and heating above 180° F. is not preferred because certain flavors and texture defects can become increasingly likely.

Vacuum.

In some embodiments, the heated mixture can be subjected to a vacuum to maximize removal of residual CO₂ from the mixture, without causing substantial product losses. A Vemag robot with vacuum set may be used, but other suitable vacuum apparatuses will be known to those of ordinary skill in the art.

Surprisingly, some embodiments can achieve a suitable close texture (non-foamy) in the emulsified cheese products without the use of a vacuum. One of ordinary skill in the art would have expected that the conditions used in the disclosed processes would not be sufficient to drive off enough CO₂ produced by the mixture comprising a carbonate and a citric acid source to avoid an undesirable foamy texture. Although the disclosed heated temperatures alone are insufficient to drive off sufficient CO₂ to avoid a foamy texture, and the disclosed emulsified cheese product pH is not low enough to drive off sufficient CO2 to avoid a foamy texture, disclosed heated temperatures and pH combined are sufficient to yield an acceptable texture.

Mechanical Shear.

Mechanical energy can be used on its own, to some effect, but is not really adequate to achieve the properties of the disclosed emulsified cheese products. However, when used with the disclosed methods and ingredients including a natural cheese, a carbonate, and a citric acid source, mechanical shear has a synergistic effect. While the a Stephan bowl chopper and a twin-screw cooker to impart shear (among other functions) are provided as examples, alternatively a homogenizer or other mechanical shear device that can reduce the protein particle size can be used.

Similarly, a mixture can be recycled through the disclosed processes as “re-work” to provide added shear. Re-work is a mixture or product taken through the process and then returned to the start of the process and used as an ingredient, with the effect of creating melt restriction. It is another example of mechanical shear, since the material is sheared twice. While not wishing to be bound by theory, the first pass shear may cause the protein structure to unfold and open up, exposing hydrophobic regions normally hidden within the native folded proteins such as casein. These hydrophobic regions are “sticky” and can cause normally folded protein to unfold in a chain reaction. This results in an emulsified cheese product with increased levels of hydrophobic bonding. Interestingly, most of the protein/protein bonding that generates cheese structure reduces in strength with increasing temperature. However hydrophobic bonds are quite unusual in that in the disclosed applications, they strengthen with increasing temperature and thus, melt restriction becomes possible.

Cooling.

Following heating and optional vacuum steps, the mixture should be cooled to an internal temperature below 40° F. as quickly as possible. Slow cooling can alter flavor and functionality. In some embodiments, the mixture may be discharged from the heating apparatus prior to cooling. In some embodiments, the mixture may be packaged prior to cooling.

### 3. Emulsified Cheese Products

In another aspect, the disclosure provides emulsified cheese products. The emulsified cheese products may be products made according to any of the disclosed methods. The disclosed emulsified cheese products may exhibit the functionality of a process cheese, with a stable emulsion and flavor equally acceptable to consumers, but with significantly reduced sodium achieved by removing emulsifiers as an ingredient during production. The emulsified cheese product may have a fresh flavor. The emulsified cheese products may have a firmer texture and/or a lower melting temperature than a comparable traditional process cheese product.

The disclosed emulsified cheese products may contain less than about 1200 mg sodium per 100 g emulsified cheese product, less than about 1100 mg sodium per 100 g emulsified cheese product, less than about 1000 mg sodium per 100 g emulsified cheese product, less than about 950 mg sodium per 100 g emulsified cheese product, less than about 900 mg sodium per 100 g emulsified cheese product, less than about 850 mg sodium per 100 g emulsified cheese product, or less than about 800 mg sodium per 100 g emulsified cheese product. In some embodiments, the disclosed emulsified cheese products may contain less than about 1500 mg sodium per 100 g emulsified cheese product, less than about 1400 mg sodium per 100 g emulsified cheese product, or less than about 1300 mg sodium per 100 g emulsified cheese product. In some embodiments, the disclosed emulsified cheese products may contain between about 100 mg to about 1500 mg, between about 200 mg to about 1500 mg, between about 300 mg to about 1500 mg, between about 400 mg to about 1500 mg, between about 500 mg to about 1500 mg, between about 600 mg to about 1500 mg, between about 700 mg to about 1500 mg, between about 800 mg to about 1500 mg, between about 900 mg to about 1500 mg, between about 1000 mg to about 1500 mg, between about 100 mg to about 1200 mg, between about 200 mg to about 1200 mg, between about 300 mg to about 1200 mg, between about 400 mg to about 1200 mg, between about 500 mg to about 1200 mg, between about 600 mg to about 1200 mg, between about 700 mg to about 1200 mg, between about 800 mg to about 1200 mg, between about 900 mg to about 1200 mg, between about 1000 mg to about 1200 mg, between about 100 mg to about 1000 mg, between about 200 mg to about 1000 mg, between about 300 mg to about 1000 mg, between about 400 mg to about 1000 mg, between about 500 mg to about 1000 mg, between about 600 mg to about 1000 mg, between about 700 mg to about 1000 mg, between about 800 mg to about 1000 mg, between about 900 mg to about 1000 mg, between about 1000 mg to about 1000 mg, between about 100 mg to about 900 mg, between about 200 mg to about 900 mg, between about 300 mg to about 900 mg, between about 400 mg to about 900 mg, between about 500 mg to about 900 mg, between about 600 mg to about 900 mg, between about 700 mg to about 900 mg, or between about 800 mg to about 900 mg sodium per 100 g emulsified cheese product.

The disclosed emulsified cheese products may comprise about 30% to about 60% moisture, about 35% to about 55% moisture, about 38% to about 52% moisture, or about 40% to about 50% moisture. The disclosed emulsified cheese products may comprise about 10% to about 35% fat, about 15% to about 35% fat, or about 20% to about 30% fat. The disclosed emulsified cheese products may comprise about 10% to about 25% protein, about 15% to about 22% protein, or about 16% to about 21% protein.

The disclosed emulsified cheese products may comprise ascorbic acid, and in some embodiments, may comprise at least about 3 mg ascorbic acid per 100 g emulsified cheese product, at least about 4 mg ascorbic acid per 100 g emulsified cheese product, at least about 5 mg ascorbic acid per 100 g emulsified cheese product, at least about 6 mg ascorbic acid per 100 g emulsified cheese product, at least about 7 mg ascorbic acid per 100 g emulsified cheese product, at least about 8 mg ascorbic acid per 100 g emulsified cheese product, at least about 9 mg ascorbic acid per 100 g emulsified cheese product, at least about 10 mg ascorbic acid per 100 g emulsified cheese product, at least about 11 mg ascorbic acid per 100 g emulsified cheese product, at least about 12 mg ascorbic acid per 100 g emulsified cheese product, at least about 13 mg ascorbic acid per 100 g emulsified cheese product, at least about 14 mg ascorbic acid per 100 g emulsified cheese product, at least about 15 mg ascorbic acid per 100 g emulsified cheese product, or at least about 16 mg ascorbic acid per 100 g emulsified cheese product.

In some embodiments, the emulsified cheese products may have a pH between about 5.0 and about 6.0, preferably about 5.6 to about 5.8.

### 4. Examples

### Example 1—Higher Moisture Spread-Type Emulsified Cheese Product

An emulsified cheese product was made as follows that has texture and emulsion stability similar to a pasteurized process cheese spread, but without the aid of emulsifiers.

TABLE 5

| Ingredient | Amount (% wt) |
|---|---|
| Cheddar Cheese | 50.75 |
| Anhydrous Milk Fat | 3.60 |
| Non-Fat Dry Milk | 10.80 |
| Table salt | 0.90 |
| Lemon Juice Concentrate | 3.30 |
| Sodium Carbonate | 0.70 |
| Steam | 8.00 |
| Water | 21.95 |
| Total | 100.00 |

All of the ingredients listed in Table 5 except for lemon juice concentrate, steam, and water were added to a Stephan bowl chopper. Those ingredients were chopped up in the blender until a homogenous mixture was formed. Lemon juice concentrate was then added to the bowl chopper and chopped for a further 1-2 minutes until a mixture with a consistency of a smooth paste was formed.

The resulting mixture was then transferred to a twin-screw cheese cooker where the water was added, and the steam was then injected to achieve a temperature in between about 160° F. to about 165° F. for 30 to 60 seconds. The mixture was then discharged from the cooker, packaged in the desired format, and cooled to below 40° F.

The process described above yielded an emulsified cheese product that had good functionality, emulsion stability, and smoothness. The emulsified cheese product had 915 mg sodium per 100 g product. The flavor was described by testers as “bright” and had a lingering, clean, cheese flavor. The emulsified cheese product compared in functionality and flavor to process cheese, but it had about 500 mg less sodium per 100 g product than a comparable process cheese made according to the same procedures but using 3% trisodium citrate rather than lemon juice concentrate and sodium carbonate (1416 mg sodium per 100 mg process cheese). Furthermore, since this sodium reduction came from removing emulsifying salts like sodium citrate, which have minimal contribution to salty flavor, there was not loss of salty flavor notes.

The emulsified cheese product had a soft to slightly firm texture that works well in many applications, especially in sauces. The emulsified cheese product had 50% moisture, 20% fat, 16.5% protein, 915 mg sodium per 100 g product and a final pH of 5.65.

### Example 2—Lower Moisture, Firmer Emulsified Cheese Product

An emulsified cheese product was made as follows that has texture and emulsion stability similar to a pasteurized process cheese, but without the aid of emulsifiers.

TABLE 6

| Ingredient | Amount (% wt) |
|---|---|
| Cheddar Cheese | 63.750 |
| Low Moisture Mozzarella Cheese | 9.000 |
| Havarti Cheese | 6.000 |
| Anhydrous Milk Fat | 4.750 |
| Non-Fat Dry Milk | 3.775 |
| Table salt | 0.600 |
| Lemon Juice Concentrate | 3.300 |
| Sodium Carbonate | 0.825 |
| Steam | 8.00 |
| Total | 100.00 |

All of the ingredients listed in Table 6 except for lemon juice concentrate and steam were added to a Stephan bowl chopper. Those ingredients were chopped up in the blender until a homogenous mixture was formed. Lemon juice concentrate was then added to the bowl chopper and chopped for a further 1-2 minutes until a mixture with a consistency of a smooth paste was formed.

The resulting mixture was then transferred to a twin-screw cheese cooker where the steam was then injected to achieve a temperature in between about 160° F. to about 165° F. for 30 to 60 seconds. The mixture was then discharged from the cooker, packaged in the desired format, and cooled to below 40° F.

The process described above yielded an emulsified cheese product that had good functionality, emulsion stability, and smoothness. The emulsified cheese product had 968 mg sodium per 100 g product. The emulsified cheese product compared in functionality and flavor to process cheese, but it had about 470 mg less sodium per 100 g product than a comparable process cheese made according to the same procedures but using 3% trisodium citrate rather than lemon juice concentrate and sodium carbonate (1437 mg sodium per 100 mg process cheese). Furthermore, since this sodium reduction came from removing emulsifying salts like sodium citrate, which have minimal contribution to salty flavor, there was not loss of salty flavor notes.

The emulsified cheese product of Example 2 had a firmer product than Example 1 and so was better suited for grating, chunking, dicing applications. The emulsified cheese product of Example 2 was also suitable for sauce and soup applications. The flavor was described by testers as delicious, bright, clean, fresh and with lingering and balanced cheese profile. The emulsified cheese product of Example 2 had 40% moisture, 31% fat, 21% protein, 968 mg sodium per 100 g product and a final pH of 5.70.

### Comparative Example 1—Traditional Process Cheese Product

A process cheese product was made in a manner analogous to Example 1, but with the ingredients including a traditional emulsifier (sodium citrate) rather than the carbonate and citrus juice used in Example 1.

TABLE 7

| Ingredient | Amount (% wt) |
|---|---|
| Cheddar Cheese | 52.25 |
| Anhydrous Milk Fat | 4.50 |
| Non-Fat Dry Milk | 9.65 |
| Table salt | 0.90 |
| Lactic acid (88%) | 0.40 |
| Sodium citrate | 3.00 |
| Steam | 8.00 |
| Water | 21.30 |
| Total | 100.00 |

The ingredients were mixed, heated, and cooled using analogous processing steps to those described for Example 1. Briefly, all of the ingredients listed in Table 7 except for lactic steam were added to a Stephan bowl chopper. Those ingredients were chopped up in the blender until a homogenous mixture was formed. The resulting mixture was then transferred to a twin-screw cheese cooker where the water was added, and the steam was then injected to achieve a temperature in between about 160° F. to about 165° F. for 30 to 60 seconds. The mixture was then discharged from the cooker, packaged in the desired format, and cooled to below 40° F.

The resulting process cheese product had 1416 mg sodium per 100 g product.

### Comparative Example 2—Traditional Process Cheese Product

A process cheese product was made in a manner analogous to Example 2, but with the ingredients including a traditional emulsifier (sodium citrate) rather than the carbonate and citrus juice used in Example 2.

TABLE 8

| Ingredient | Amount (% wt) |
|---|---|
| Cheddar Cheese | 64.750 |
| Low Moisture Mozzarella Cheese | 9.000 |
| Havarti Cheese | 6.000 |
| Anhydrous Milk Fat | 4.750 |
| Non-Fat Dry Milk | 3.900 |
| Table salt | 0.600 |
| Sodium citrate | 3.000 |
| Steam | 8.00 |
| Total | 100.00 |

The ingredients were mixed, heated, and cooled using analogous processing steps to those described for Example 2. Briefly, all of the ingredients listed in Table 8 except for steam were added to a Stephan bowl chopper. Those ingredients were chopped up in the blender until a homogenous mixture was formed. The resulting mixture was then transferred to a twin-screw cheese cooker where the steam was then injected to achieve a temperature in between about 160° F. to about 165° F. for 30 to 60 seconds. The mixture was then discharged from the cooker, packaged in the desired format, and cooled to below 40° F.

The resulting process cheese product had 1437 mg sodium per 100 g product.

### Comparative Example 3—Cheese Sauce

A cheese sauce was made using lemon juice and baking soda (sodium bicarbonate). Two lemons were squeezed to obtain 110 g fresh-squeezed lemon juice. The lemon juice was then mixed with 38 g sodium bicarbonate and stirred until foaming subsided. Water was then added, and the mixture was heated. The cheddar cheese was added one handful at a time, with frequent whisking and maintaining the temperature below boiling. Once all of the cheese had been incorporated, the mixture was removed from heat and the remaining ingredients as shown in Table 9 were added.

TABLE 9

| Ingredient | Amount (g) | Amount (% wt) |
|---|---|---|
| Lemon Juice | 110 | 16.41 |
| Baking Soda | 38 | 5.67 |
| Shredded Cheese | 226 | 33.73 |
| Water | 235 | 35.07 |
| Jalapeno | 20 | 3.00 |
| Tomato Puree | 40 | 5.97 |
| Milk | 1 | 0.15 |
| Total | 670 | 100.00 |

The resulting product had a grainy and gooey texture, with a nacho cheese taste and having a slight “artificial twang” flavor. The product produced as described above forms a skin, and tasters reported an unpleasant taste (stating that the product “tastes funny,” is too salty, and has excessive lemon flavor). The product exhibited graininess, indicative of poor protein hydration and likely to result in oiling off and skin formation.

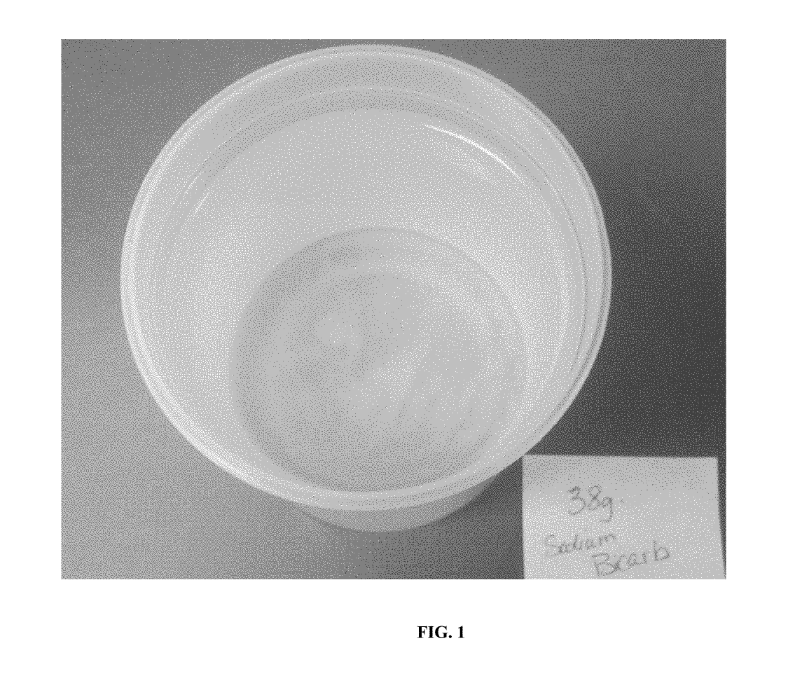

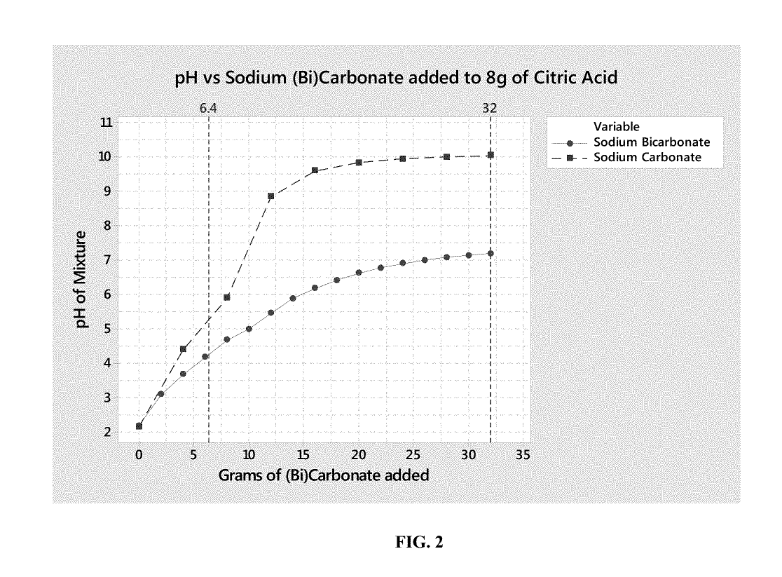

The final cheese sauce had 71% moisture, 11% fat and 8% protein. The product also had an alkaline pH due the high carbonate levels. In two separate trials we added carbonates to 8 g of citric acid and noted the resulting pH. The ingredients for Comparative Example 3 included a sodium bicarbonate to citric acid ratio level in excess of 38 g of bicarbonate to 8 g of citric acid, which would be quite alkaline (see FIGS. 1-2).

### Example 3—Cheese Product Formulations Using a Range of Lemon Juice Concentrates

Three different cheese product formulations were made using 3 different lemon juice concentrations; 3.30 wt % (Table 10), 4.95 wt % (Table 11), and 6.60 wt % (Table 12). In each formulation, the starting barrel cheese was ground. All of the ingredients for the formulations except for lemon juice concentrate and water were blended until a homogenous mixture was formed. The resulting mixture was then transferred to a twin-screw cheese cooker where the lemon juice was added. A portion of the water (2 pounds) was added and the mixture was cooked to 165° F. After reaching the target temperature of 165° F., the remaining quantity of water was added.

TABLE 10
3.30% Lemon Juice Formulation

| Ingredient | Amount (% wt) |
|---|---|
| Cheese - Barrel | 51.42 |
| Concentrated Milk Fat | 5.50 |
| Non Fat Dry Milk | 8.88 |
| Lemon Juice Concentrate | 3.30 |
| Salt | 0.90 |
| Sodium Carbonate | 0.70 |
| Steam | 8.00 |
| Water | 21.30 |
| Total | 100 |

TABLE 11
4.95% Lemon Juice Formulation

| Ingredient | Amount (% wt) |
|---|---|
| Cheese - Barrel | 51.42 |
| Concentrated Milk Fat | 5.50 |
| Non Fat Dry Milk | 8.88 |
| Lemon Juice Concentrate | 4.95 |
| Salt | 0.90 |
| Sodium Carbonate | 1.125 |
| Steam | 8.00 |
| Water | 19.225 |
| Total | 100 |

TABLE 12
6.60% Lemon Juice Formulation

| Ingredient | Amount (% wt) |
|---|---|
| Cheese - Barrel | 51.42 |
| Concentrated Milk Fat | 5.50 |
| Non Fat Dry Milk | 6.88 |
| Lemon Juice Concentrate | 6.60 |
| Salt | 0.90 |
| Sodium Carbonate | 1.50 |
| Steam | 8.00 |
| Water | 19.20 |
| Total | 100 |

The moisture content, pH, total fat, total protein, salt content, and sodium content for these three formulations are listed in Table 13. All three levels of lemon juice yielded cheese products with a semi-soft/firm homogenous texture and a stable emulsion. At the higher use levels, the lemon juice began to be detected by more sensitive tasters. While all were acceptable, the lower lemon juice concentrate 3.30% lemon juice (Table 10) was preferred. The cheese flavor seemed to be intensified in all examples, being described as medium to sharp with increasing lemon juice usage levels, whereas a mild flavor would be expected with more traditional emulsifier systems.

TABLE 13

| | | | | | | Sodium |
|---|---|---|---|---|---|---|
| | Moisture | | | Total | Salt | (mg/100 g |
| | Content | | Total | Protein | Content | process |
| | (%) | pH | Fat (%) | (%) | (%) | cheese) |
| 3.30% Lemon | 50.621 | 5.7 | 22.558 | 16.056 | 1.951 | 1010.636 |
| Juice | | | | | | |
| 4.95% Lemon | 49.384 | 5.7 | 22.574 | 16.104 | 1.951 | 1195.761 |
| Juice | | | | | | |
| 6.60% Lemon | 50.135 | 5.7 | 22.576 | 15.453 | 1.923 | 1359.182 |
| Juice | | | | | | |

### Example 4—Cheese Product Formulations Using a Range of Citric Acid

Three different cheese product formulations were made using 3 different citric acid concentrations corresponding to the lemon juice concentrations in Example 3; 1.1 wt % (Table 14), 1.63 wt % (Table 15), and 2.178 wt % (Table 16). In each formulation, the starting barrel cheese ground and all of the ingredients for the formulations except for lemon juice concentrate and water were blended until a homogenous mixture was formed. The resulting mixture was then transferred to a twin-screw cheese cooker and the citric acid was added. A portion of the water, 2 pounds, was added and the mixture was cooked to 165° F. After reaching the target temperature of 165° F., the remaining quantity of water was added, targeting a moisture content of 50% and a pH of 5.7.

TABLE 14
1.1% Citric Acid Formulation

| Ingredient | Amount (% wt) |
|---|---|
| Cheese - Barrel | 51.42 |
| Fat-Salted Butter | 5.50 |
| Non Fat Dry Milk | 8.88 |
| Citric Acid | 1.10 |
| Salt | 0.90 |
| Sodium Carbonate | 0.70 |
| Steam | 8.00 |
| Water | 23.50 |
| Total | 100 |

TABLE 15
1.63% Citric Acid Formulation

| Ingredient | Amount (% wt) |
|---|---|
| Cheese - Barrel | 51.42 |
| Fat - Salted Butter | 5.50 |
| Non Fat Dry Milk | 8.89 |
| Citric Acid | 1.63 |
| Salt | 0.90 |
| Sodium Carbonate | 1.00 |
| Steam | 8.00 |
| Water | 22.66 |
| Total | 100 |

TABLE 16
2.178% Citric Acid Formulation

| Ingredient | Amount (% wt) |
|---|---|
| Cheese - Barrel | 51.42 |
| Fat - Salted Butter | 5.50 |
| Non Fat Dry Milk | 7.602 |
| Citric Acid | 2.178 |
| Salt | 0.90 |
| Sodium Carbonate | 1.40 |
| Steam | 8.00 |
| Water | 23.00 |
| Total | 100 |

The moisture content, pH, total fat, total protein, salt content, and sodium content for these three formulations are listed in Table 17. The resulting cheese products had a homogeneous semi-soft/firm texture. The cheese flavor seemed to be intensified in all examples, being described as medium to sharp with increasing citric acid usage levels, whereas a mild flavor would be expected with more traditional emulsifiers.

TABLE 17

| | | | | | | Sodium |
|---|---|---|---|---|---|---|
| | Moisture | | | Total | Salt | (mg/100 g |
| | Content | | Total | Protein | Content | process |
| | (%) | pH | Fat (%) | (%) | (%) | cheese) |
| 1.1% Citric | 51.185 | 5.7 | 22.525 | 15.958 | 1.951 | 1009.201 |
| Acid | | | | | | |
| 1.63% Citric | 50.36 | 5.7 | 22.525 | 15.962 | 1.951 | 1139.371 |
| Acid | | | | | | |
| 2.178% | 50.68 | 5.7 | 22.515 | 15.511 | 1.933 | 1312.924 |
| Citric Acid | | | | | | |

### Example 5—Cheese Product Formulations without Emulsifiers

Two different cheese product formulations were made without emulsifiers (Tables 17 and 18). For a high cheese formulation (Table 18), the starting cheeses were chopped and all of the powdered ingredients were blended until a homogenous mixture was formed. The resulting mixture was then transferred to a twin-screw cheese cooker and the mixture was cooked to 155° F.

TABLE 18
High Cheese, No Emulsifiers Formulation

| Ingredient | Amount (% wt) |
|---|---|
| Cheese - Barrel | 49.75 |
| Cheese - Sharp White Cheddar | 30.00 |
| Anhydrous Milkfat | 4.75 |
| Non Fat Dry Milk | 4.40 |
| Salt | 0.60 |
| Steam | 8.00 |
| Water | 2.50 |
| Total | 100 |

For a decreased cheese formulation (Table 19), the starting cheeses were ground and all of the powdered ingredients were blended until a homogenous mixture was formed. The resulting mixture was then transferred to a twin-screw cheese cooker, half of the water was added, and the mixture was cooked to 155° F. After reaching the target temperature of 155° F., the remaining water and lactic acid was added.

TABLE 19
Decreased Cheese, No Emulsifiers Formulation

| Ingredient | Amount (% wt) |
|---|---|
| Cheese - Barrel | 16.50 |
| Cheese - Barrel 2 | 10.00 |
| Cheese - Sharp White Cheddar | 27.25 |
| Anhydrous Milkfat | 4.50 |
| Non Fat Dry Milk | 11.15 |
| Salt | 0.90 |
| Lactic Acid (88%) | 0.40 |
| Steam | 8.00 |
| Water | 21.30 |
| Total | 100 |

The moisture content, pH, total fat, total protein, salt content, and sodium content for these two formulations are listed in Table 20. The resulting non-emulsified cheese products had a semi-soft/firm texture.

TABLE 20

| | | | | | | Sodium |
|---|---|---|---|---|---|---|
| | Moisture | | | Total | Salt | (mg/100 g |
| | Content | | Total | Protein | Content | process |
| | (%) | pH | Fat (%) | (%) | (%) | cheese) |
| High Cheese, | 40.097 | 5.5 | 31.790 | 21.128 | 2.031 | 735.668 |
| No | | | | | | |
| Emulsifiers | | | | | | |
| Decreased | 49.719 | 5.7 | 22.572 | 17.041 | 1.943 | 690.753 |
| Cheese, No | | | | | | |
| Emulsifiers | | | | | | |

### Example 6—Oil Off Test Procedure

The Oil Off Test procedure was used to measure the amount of free oil in sauce, after freeze thaw. 242.50 grams water, 7.50 grams Thermflo Starch, and 250 grams of the cheese were weighed. In a double boiler, water was added and starch was whisked into the water. Once the temperature reached about 120° F., the cheese was added. The mixture was whisked until the cheese was completely melted and the temperature had reached 180° F. The double boiler was placed in an ice bath to cool down below 100° F. The mixture was poured into a Ziploc bag and laid down flat in a freezer and allowed to freeze for about 48 hours. After freezing, the Ziploc bag was placed in a 155° F. hot water bath for 2 hours. After 2 hours, the bag was very carefully removed and any free oil was poured into a glass graduated cylinder. The bag was placed back into the hot water bath for 30 minutes. The bag was removed and any free oil was poured into the glass graduated cylinder and a reading of the level of free oil was measured in milliliters. Alternatively, a Visual score of 0 to 5 was assigned as shown in Table 21.

TABLE 21

| | |
|---|---|
| Milliliters of visible free oil | Visual Score |

| | | |
|---|---|---|
| Zero to 3 | ml | 0 |
| 4 +/− 1 | ml | 1 |
| 6 +/− 1 | ml | 2 |
| 8 +/− 1 | ml | 3 |
| 10 +/− 1 | ml | 4 |
| Greater than 11 | ml | 5 |

Formulations from Examples 3, 4, and 5 were compared using the oil off test procedure as a measurement for separation of oil (Table 22). The results show that without inclusion of an emulsifier there is unacceptable separation of oil in the product. No difference in oil separation is apparent when the formulation contains lemon juice or the equivalent amount of citric acid.

TABLE 22
Oil Off Separation Test Results

| | Equivalent | Visual Score for |
|---|---|---|
| Formulation | Citric Acid % | Separation of Oil |
| Citric Acid 2.178% | 2.17 | 0 (None detected) |
| Citric Acid 1.63% | 1.63 | 1 (Very Minor) |
| Citric Acid 1.1% | 1.10 | 2 (Minor) |
| Lemon Juice 6.6% | 2.05 | 0 (None detected) |
| Lemon Juice 4.95% | 1.53 | 1 (Very Minor) |
| Lemon Juice 3.3% | 1.02 | 2 (Minor) |
| High Cheese, | 0 | 5 (Unacceptable separation) |
| No Emulsifiers | | |
| Decreased Cheese, | 0 | 5 (Unacceptable separation) |
| No Emulsifiers | | |

It is understood that the foregoing detailed description and accompanying examples are merely illustrative and are not to be taken as limitations upon the scope of the invention, which is defined solely by the appended claims and their equivalents.

Various changes and modifications to the disclosed embodiments will be apparent to those skilled in the art. Such changes and modifications, including without limitation those relating to the chemical structures, substituents, derivatives, intermediates, syntheses, compositions, formulations, or methods of use of the invention, may be made without departing from the spirit and scope thereof.

For reasons of completeness, various aspects of the invention are set out in the following numbered clauses:

Clause 1. A method for producing an emulsified cheese product, comprising: mixing ingredients comprising natural cheese in an amount from about 45% to about 90% by weight, a carbonate in an amount from about 0.5% to about 1.0% sodium carbonate equivalent by weight, and a citric acid source in an amount from about 3.0% to about 5.0% lemon juice concentrate equivalent by weight to form a mixture; heating the mixture to a heated temperature between about 150° F. and about 180° F.; and cooling the mixture to less than about 40° F.

Clause 2. The method of clause 1, wherein the carbonate is sodium carbonate.

Clause 3. The method of clause 1, wherein the citric acid source is a citrus juice.

Clause 4. The method of clause 3, wherein the citrus juice is lemon juice concentrate.

Clause 5. The method of clause 3, wherein the citrus juice is lemon juice.

Clause 6. The method of clause 1, wherein the citric acid source is citric acid.

Clause 7. The method of any one of clauses 1-6, wherein the citric acid source is provided in an amount of about 3.3% lemon juice concentrate equivalent by weight.

Clause 8. The method of clause 1, the ingredients further comprising water.

Clause 9. The method of clause 8, wherein some or all of the water is provided as steam.

Clause 10. The method of clause 1, the ingredients further comprising a butterfat source.

Clause 11. The method of clause 1, the ingredients further comprising an amphipathic molecule.

Clause 12. The method of clause 1, the ingredients further comprising a hydrocolloid.

Clause 13. The method of clause 1, the ingredients further comprising non-fat dry milk.

Clause 14. The method of clause 1, further comprising applying mechanical shear to the mixture.

Clause 15. The method of clause 1, further comprising applying a vacuum to the mixture.

Clause 16. The method of clause 1, wherein the resulting emulsified cheese product has a pH between about 5.0 and about 6.0.

Clause 17. The method of clause 16, wherein the resulting emulsified cheese product has a pH between about 5.6 and about 5.8.

Clause 18. The method of clause 1, wherein the heated temperature is between about 160° F. and about 165° F.

Clause 19. The method of clause 1 or clause 18, wherein the heating step comprises maintaining the mixture at the heated temperature for a period of time of between about 30 seconds and about 60 seconds.

Clause 20. The method of clause 9, wherein heated temperature is achieved by adding steam to the mixture.

Clause 21. The method of clause 1, wherein the resulting emulsified cheese product has a sodium level of about 900 mg or less per 100 g emulsified cheese product.

Clause 22. The method of any of the preceding clauses, wherein the ingredients do not include an emulsifier.

Clause 23. An emulsified cheese product produced according to the method of any of the preceding clauses.

Clause 24. An emulsified cheese product comprising about 38% to about 52% moisture, about 15% to about 35% fat, about 15% to about 22% protein, at least about 4 mg ascorbic acid per 100 g emulsified cheese product, and about 950 mg or less sodium per 100 g emulsified cheese product.

Clause 25. The emulsified cheese product of clause 24, wherein the emulsified cheese product has a pH between about 5.0 and about 6.0.

Clause 26. The emulsified cheese product of clause 25, wherein the emulsified cheese product has a pH between about 5.6 and about 5.8.

Clause 27. A method for producing an emulsified cheese product, the method comprising: mixing ingredients comprising natural cheese in an amount from about 45% to about 90% by weight, an alkali in an amount from about 0.1% to about 1.0% sodium carbonate equivalent by weight to result in a emulsified cheese product having a pH of about 5.0 to about 6.0, and a citric acid source in an amount from about 3.0% to about 5.0% lemon juice concentrate equivalent by weight to form a mixture; heating the mixture to a heated temperature between about 150° F. and about 180° F.; and cooling the mixture to less than about 40° F.

Clause 28. The method of clause 27, wherein the alkali comprises at least one of potassium hydroxide, sodium hydroxide, a carbonate, a bicarbonate, or a combination thereof.

Clause 29. The method of clause 27 or 28, wherein the alkali comprises a carbonate.

Clause 30. The method of any one of clauses 27-29, wherein the alkali is sodium carbonate.

Clause 31. The method of any one of clauses 27-30, wherein the citric acid source is a citrus juice or citric acid.

Clause 32. The method of clause 31, wherein the citrus juice is lemon juice concentrate or lemon juice.

Clause 33. The method of any one of clauses 27-32, wherein the citric acid source is provided in an amount of about 3.3% lemon juice concentrate equivalent by weight.

Clause 34. The method of any one of clauses 27-33, the ingredients further comprising water.

Clause 35. The method of clause 34, wherein some or all of the water is provided as steam.

Clause 36. The method of any one of clauses 27-35, the ingredients further comprising a butterfat source.

Clause 37. The method of any one of clauses 27-36, the ingredients further comprising an amphipathic molecule.

Clause 38. The method of any one of clauses 27-37, the ingredients further comprising a hydrocolloid.

Clause 39. The method of any one of clauses 27-38, the ingredients further comprising non-fat dry milk.

Clause 40. The method of any one of clauses 27-39 further comprising applying mechanical shear to the mixture.

Clause 41. The method of any one of clauses 27-40, further comprising applying a vacuum to the mixture.

Clause 42. The method of any one of clauses 27-41, wherein the resulting emulsified cheese product has a pH between about 5.6 and about 5.8.

Clause 43. The method of any one of clauses 27-42, wherein the heated temperature is between about 160° F. and about 165° F.

Clause 44. The method of any one of clauses 27-43, wherein the heating step comprises maintaining the mixture at the heated temperature for a period of time of between about 30 seconds and about 60 seconds.

Clause 45. The method of any one of clauses 27-44, wherein heated temperature is achieved by adding steam to the mixture.

Clause 46. The method of any one of clauses 27-45, wherein the resulting emulsified cheese product has a sodium level of about 900 mg or less per 100 g emulsified cheese product.

Clause 47. The method of any one of clauses 27-46, wherein at least 10% of the natural cheese has been aged for at least 6 months.

Clause 48. The method of any one of clauses 27-47, wherein the ingredients do not include an emulsifier.

Clause 49. An emulsified cheese product produced according to the method of any one of clauses 27-48.

Clause 50. The emulsified cheese product of clause 49, wherein the emulsified cheese product comprises about 38% to about 52% moisture, about 15% to about 35% fat, about 15% to about 22% protein, at least about 4 mg ascorbic acid per 100 g emulsified cheese product, and about 950 mg or less sodium per 100 g emulsified cheese product.

Clause 51. An emulsified cheese product comprising about 38% to about 52% moisture, about 15% to about 35% fat, about 15% to about 22% protein, at least about 4 mg ascorbic acid per 100 g emulsified cheese product, and about 950 mg or less sodium per 100 g emulsified cheese product.

Clause 52. The emulsified cheese product of clause 50 or 51, wherein the emulsified cheese product has a pH between about 5.0 and about 6.0.

Clause 53. The emulsified cheese product of clause 52, wherein the emulsified cheese product has a pH between about 5.6 and about 5.8.

We claim:

1. A method for producing an emulsified cheese product, the method comprising:
mixing ingredients comprising natural cheese in an amount from about 45% to about 90% by weight, an alkali in an amount from about 0.1% to about 1.0% sodium carbonate equivalent by weight to result in a emulsified cheese product having a pH of about 5.0 to about 6.0, and a citric acid source in an amount from about 3.0% to about 5.0% lemon juice concentrate equivalent by weight to form a mixture;
heating the mixture to a heated temperature between about 150° F. and about 180° F.; and
cooling the mixture to less than about 40° F.

2. The method of claim 1, wherein the alkali comprises at least one of potassium hydroxide, sodium hydroxide, a carbonate, a bicarbonate, or a combination thereof.

3. The method of claim 1, wherein the alkali is sodium carbonate.

4. The method of claim 1, wherein the citric acid source is a citrus juice or citric acid.

5. The method of claim 4, wherein the citrus juice is lemon juice concentrate or lemon juice.

6. The method of claim 1, wherein the citric acid source is provided in an amount of about 3.3% lemon juice concentrate equivalent by weight.

7. The method of claim 1, the ingredients further comprising water.

8. The method of claim 7, wherein some or all of the water is provided as steam.

9. The method of claim 1, the ingredients further comprising a butterfat source, an amphipathic molecule, a hydrocolloid, or non-fat dry milk.

10. The method of claim 1, further comprising applying mechanical shear to the mixture or applying a vacuum to the mixture.

11. The method of claim 1, wherein the resulting emulsified cheese product has a pH between about 5.6 and about 5.8.

12. The method of claim 1, wherein the heated temperature is between about 160° F. and about 165° F.

13. The method of claim 1, wherein the heating step comprises maintaining the mixture at the heated temperature for a period of time of between about 30 seconds and about 60 seconds.

14. The method of claim 13, wherein heated temperature is achieved by adding steam to the mixture.

15. The method of claim 1, wherein the resulting emulsified cheese product has a sodium level of about 900 mg or less per 100 g emulsified cheese product.

16. The method of claim 1, wherein at least 10% of the natural cheese has been aged for at least 6 months.

17. The method of claim 1, wherein the ingredients do not include an emulsifier.

18. An emulsified cheese product produced according to the method of claim 1.

19. The emulsified cheese product of claim 18, wherein the emulsified cheese product comprises about 38% to about 52% moisture, about 15% to about 35% fat, about 15% to about 22% protein, at least about 4 mg ascorbic acid per 100 g emulsified cheese product, and about 950 mg or less sodium per 100 g emulsified cheese product.

20. The emulsified cheese product of claim 19, wherein the emulsified cheese product has a pH between about 5.6 and about 5.8.
